(19) United States
(12) Patent Application Publication
(10) Pub. No.: US 2025/0390720 A1
(43) Pub. Date: Dec. 25, 2025

(54) GUIDED INTELLIGENT SYNTHETIC DATA GENERATION

(71) Applicant: Oracle International Corporation, Redwood Shores, CA (US)

(72) Inventor: Dongwook Jang, Lisle, IL (US)

(21) Appl. No.: 18/752,454

(22) Filed: Jun. 24, 2024

(51) Int. Cl. G06N 3/0475; G06N 3/096

(52) U.S. Cl. CPC G06N 3/0475; G06N 3/096

(57) ABSTRACT

A data management system receives a request to generate synthetic data based on source data, and determines a set of columns of the source data that satisfy a correlation condition and at least one other column of the source data that does not satisfy the correlation condition. The data management system prompts a large language model to generate synthetic data for the set of columns based at least in part on first source data values for the set of columns, and generates synthetic data for the at least one other column based at least in part on a distribution of second source data values for the at least one other column. The data management system merges the synthetic data to generate a resulting synthetic set of data of the plurality of columns. The data management system stores the resulting synthetic set of data in a repository of training data, and uses the training data to train a machine learning model.

### BACKGROUND

Machine learning models are trained using data. Real-world data is useful for training models and helps the models accurately make predictions according to real world conditions. Real world data is often expensive, but the expense comes with the benefit of higher-quality models that come from more robust real-world datasets. Machine learning models benefit from large amounts of data to produce well-trained, high-performance models. In the absence of large amounts of data, models might make predictions or decisions that are less accurate or less efficient.

Even if accurate data can be procured, the time and expense to procure the data may result in significant competitive disadvantages for products and services built on top of those products. For example, delays in data procurement may result in delays in releasing a production service, which will result in a lack of revenue for that service.

Taking shortcuts in procuring data to avoid the time and expense costs can result in poor model performance as the model performs only as well as the data used to train the model. Data that a company has immediately available for training might be limited, and such data may lead to blind spots when training a model, particularly if the model did not exist when the data was generated. In this scenario, particular edge cases that should be addressed by the model might not have been considered in the available data. Most data sets that are useful for model training are not collections of random values, but rather values that promote accurate predictions for a particular scenario in a target domain. Using data generated to address other scenarios in other domains may lead to a model that is not well-trained to make predictions for the particular scenario in the target domain.

### BRIEF SUMMARY

In some embodiments, a data management system receives a request to generate synthetic data based on source data, and determines a set of columns of the source data that satisfy a correlation condition and at least one other column of the source data that does not satisfy the correlation condition. The data management system prompts a large language model to generate synthetic data for the set of columns based at least in part on first source data values for the set of columns, and generates synthetic data for the at least one other column based at least in part on a distribution of second source data values for the at least one other column. The data management system merges the synthetic data to generate a resulting synthetic set of data of the plurality of columns. The data management system stores the resulting synthetic set of data in a repository of training data, and uses the training data to train a machine learning model.

A computer-implemented method includes receiving a request to generate synthetic data based on source data comprising a plurality of columns, determining a set of columns of the source data that satisfy one or more correlation conditions and at least one other column of the source data that does not satisfy the one or more correlation conditions, prompting a large language model to generate first synthetic data for at least the set of columns based at least in part on first source data values for the set of columns, generating second synthetic data for the at least one other column based at least in part on a distribution of second source data values for the at least one other column, merging the first synthetic data with the second synthetic data to generate a resulting synthetic set of data of the plurality of columns, storing the resulting synthetic set of data in a repository of training data, and using the training data to train a machine learning model.

In a further embodiment, determining the set of columns of the source data that satisfy the one or more correlation conditions includes determining a Pearson correlation for numeric columns and a similarity measure of vector embeddings for text columns.

A computer-implemented method may also include causing display, on a user interface, of an option to remove a particular column from columns that would satisfy one or more correlation conditions, where the particular column, if removed, is not included in columns for which the large language model is prompted and is included in columns for which the second synthetic data is generated.

A computer-implemented method may also include determining an upper limit and a lower limit of the second source data values, based at least in part on the distribution of second source data values for the at least one other column. The generating the second synthetic data may include sampling from a range, defined by the upper limit and the lower limit of the second source data values.

Prompting the large language model to generate the first synthetic data may include generating a plurality of prompts, each prompt including examples of a different subset of the first source data values for the first set of dimensions, and prompting the large language model with the plurality of prompts.

Prompting the large language model to generate the first synthetic data may include generating a first prompt comprising a first set of examples of the first source data values for the set of columns, wherein the first prompt requests a first quantity of synthetic data items, generating a second prompt comprising a second set of examples of the first source data values for the set of columns, wherein the second prompt requests a second quantity of synthetic data items that is different from the first quantity of synthetic data items; wherein the first set of examples is different from the second set of examples, and prompting the large language model with the first prompt and the second prompt.

A computer-implemented method may also include receiving a first set of the first quantity of synthetic data items from the large language model and scoring a diversity of the first set of the first quantity of synthetic data items. The second quantity may be selected based at least in part on the diversity of the first set of the first quantity of synthetic data items.

The set of columns may include a first column of a first dimension and a second column of a second dimension. The request may identify the first column but does not identify the second column. A computer-implemented method may also include identifying the second column for inclusion in the source data based at least in part on a reference from the first dimension to a third column of the second dimension, and discovering the second column as a roll-up of the third column. The first source data values may include values from the second column and the third column, and storing the resulting synthetic set of data in the repository of training data may update the first dimension membership of the third column on which the second column is determined. The second column first dimension membership of the second column may be automatically determined as a roll-up value based at least in part on the first dimension membership of the third column.

The prompting the large language model to generate the first synthetic data may include generating a prompt including an example range of existing values of a column of the set of columns and at least a subset of the first source data values of the set of columns, and prompting the large language model with the prompt.

Prompting the large language model to generate the first synthetic data may include generating a prompt including a guideline indicating an aspect of a first column of the set of columns that depends on an aspect of a second column of the set of columns and at least a subset of the first source data values of the set of columns, and prompting the large language model with the prompt.

In various aspects, a system is provided that includes one or more data processors and a non-transitory computer-readable storage medium containing instructions which, when executed on the one or more data processors, cause the one or more data processors to perform part or all of one or more methods disclosed herein.

In various aspects, a computer-program product is provided that is tangibly embodied in a non-transitory machine-readable storage medium and that includes instructions configured to cause one or more data processors to perform part or all of one or more methods disclosed herein.

As used herein, the terms “first,” “second,” “third,” “fourth,” etc. are used as naming conventions to refer to separate items in a set of items or steps in a set of steps. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates flowchart of a set of operations for implementing certain aspects of a data management system.

FIG. 2 illustrates a simplified diagram of a distributed system for implementing certain aspects.

FIG. 3A illustrates an example user interface for source data entry and options for user selection of correlation of data columns.

FIG. 3B illustrates another example user interface for source data entry and options for user selection of correlation of data columns.

FIG. 3C illustrates another example user interface, depicting a user election to disregard detected correlations.

FIG. 4A illustrates an example prompt for synthetic data generation.

FIG. 4B illustrates another example prompt for synthetic data generation.

FIG. 5 illustrates an example source data and resulting target data as used in a data management system.

FIG. 6 depicts a simplified diagram of a distributed system for implementing certain aspects.

FIG. 7 is a simplified block diagram of one or more components of a system environment by which services provided by one or more components of an embodiment system may be offered as cloud services, in accordance with certain aspects.

FIG. 8 illustrates an example computer system that may be used to implement certain aspects.

### DETAILED DESCRIPTION

A data management system receives a request to generate synthetic data based on source data, and determines whether each column of the source data satisfies a correlation condition. The data management system uses a large language model to generate synthetic data for correlated columns and uses a distribution of the source data for uncorrelated columns. The data management system merges and stores the synthetic data in a repository of training data, and uses the training data to train a machine learning model.

In various embodiments, the data management system is implemented using non-transitory computer-readable storage media to store instructions which, when executed by one or more processors of a computer system, cause display of the user interface and processing of the received input to the data management system. The data management system may be implemented on a local or cloud-based computer system that includes processors and a display for showing the user interface to a user of the data management system. The computer system may communicate with client computer systems for displaying the data management system user interface.

A description of the data management system is provided in the following sections:
STRUCTURED DATA
TRAINING A MACHINE LEARNING MODEL
CONFIGURING TRAINING DATA TO USE FOR TRAINING A MACHINE LEARNING MODEL
AUTOMATICALLY DETERMINING CORRELATIONS
GENERATING SYNTHETIC DATA FOR CORRELATED COLUMNS
GENERATING THE LARGE LANGUAGE MODEL PROMPT
GENERATING DATA FOR NON-CORRELATED COLUMNS
APPLICATION OF SYNTHETIC DATA

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Structured Data

Data is stored in data structures such as tables or other objects in a database. Each item or record of data may include flat fields that store values describing characteristics of the record of data and/or relational fields that hold references to other records of data. As used herein, the terms “field” and “column” are used interchangeably. A column or field of a record is a logical container in the record for holding a value or a reference to another record. In one example, a record may include a name field to store a name value of the record, description field(s) to store description value(s) of the field, and one or more key value fields to store references to key values of other records. A dimension is an object holding records that reference other records using key values of other records or are referenced by other records using a key value that uniquely identifies the records in the dimension.

For example, an office record in an office dimension may include a key value field that references a location record for a region of office locations. In the example, the location record may include additional flat fields and/or relational fields to reference other records. For example, the location record may store a list of offices in the region by listing references using key values that refer back to records of the office object corresponding to the different offices in the region.

The data may relate to other stored data or be associated with other stored data in a hierarchy, and each data record or node may store information about a particular entity or item described by a particular position in the hierarchy. The data records may be stored across multiple dimensions of data that include records corresponding to each dimension that may be updated or maintained separately, with some dimensions referencing other dimensions to provide added context to the dataset. For example, a location dimension may provide more detailed information about particular locations, and the location dimension may be referenced by an entity in an entity dimension, for example referencing a location of the entity. The location dimension may include roll-up data structures that explain the location at higher levels such as region or country or at lower levels such as state or city, or even lower levels such as address or pertaining to flat field characteristics associated with the address (e.g., parking characteristics, access codes, indoor space description(s), outdoor space description(s), service(s) offered at the address, employee(s) working at the address, etc.).

Datasets in one or multiple dimensions may be used to train a machine learning model to predict missing characteristics of the data or to make decisions based on the data. For example, the machine learning model may account for past predictions or decisions that resulted in labeled outcome and use the labeled outcome to predict new outcomes. Data about the past predictions or decisions may be provided as values of columns from the dataset to the machine learning model as training data.

### Training a Machine Learning Model

Machine learning models may be trained using labeled sets of data or data having characteristics that are targeted for use in making predictions. The labeled data may be divided into training data and validation data. For example, 80% of the labeled data may be used as training data, and 20% of the training data may be used as validation data. The training data is used to train a model. For example, the model may be trained by removing the actual labels from the labeled data, using the model to generate a predicted label in place of the missing actual label, and adjusting the model to promote a better alignment between predicted labels and the missing actual labels. The adjustments to the model may be made iteratively and referred to as training and tuning the model as the model becomes better at predicting the missing labels. During iterations of training and tuning the model, versions of the model that better predict labels may be preserved, and versions of the model that do worse at predicting labels may be discarded.

The machine learning models may be validated to determine how well the machine learning model is performing at making predictions of missing labels. Once the model has been trained and tuned to make accurate predictions on the training data, which then becomes known to the model, validation data may be used to determine how well the model performs against unknown data. Validation data may be fed into the trained model to determine if a performance of the model meets performance criteria. For example, the model may make accurate predictions 95% of the time for the validation data even though the model was not directly trained or tuned on any of the validation data. If the model is validated, the model may proceed to be used in a production environment as a model that is expected to meet performance criteria.

If synthetic data is generated, after generation and merging of target data, the target data may be incorporated into a production system, such as training a target model or identifying the target data as demo data. In one embodiment, the target model is a part of a prediction system, such as a human capital management tool that uses the target model for predicting what a user is going to type into a field after an initial input has been typed into the field. In another embodiment, the target model is part of a data prediction system, such as a supply chain tool that uses the target model in making predictions for missing data of items in inventory. In yet another embodiment, the target model is part of a device controller that makes decisions based on data. In yet another embodiment, the target model is an analytic system, such as a correction tool that uses the model to make corrections to provided data or generate alerts based on provided data. In yet another embodiment, the target model is part of a knowledge management system, such as a user assistance system that uses the target model for answering questions based on ambiguous input by disambiguating the input using the model.

For use with a target model, the target data serves as labeled data, which can be divided into training data and validation data (e.g. by randomly selecting a portion of the labeled data to serve as training data and another portion to serve as validation data) to train a new target model or tune an existing target model. Alternatively the target data may be identified as model data or demonstrative data, such as for use in presenting data without disclosure of details about the original source data.

### Configuring Training Data to Use for Training a Machine Learning Model

In various embodiments, a machine learning model may be trained using synthetic data, such as data that is based on real-world data. Synthetic data may be generated based on source data provided by a user along with criteria for generating a resulting target data. The target data, generated based on the source data, may then be used to train or tune a machine learning model to improve the accuracy or efficiency of the model at performing one or more tasks for which the model is trained.

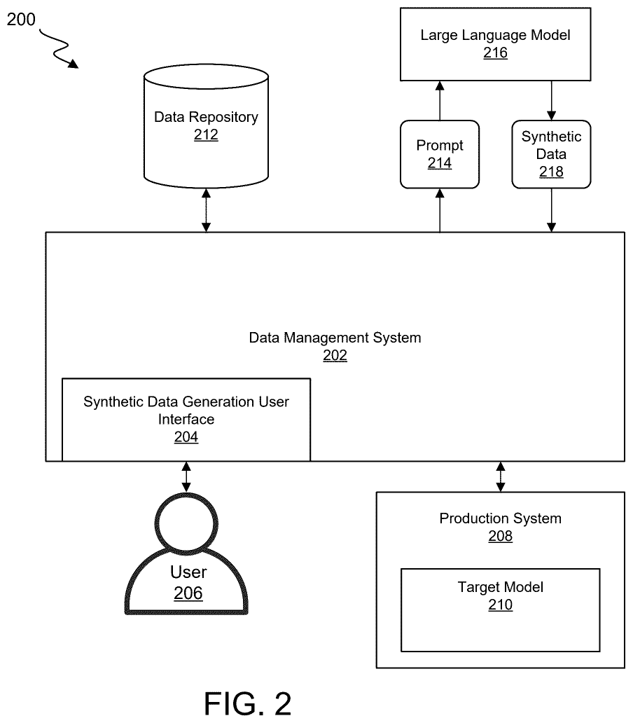

FIG. 2 depicts a distributed system 200 for carrying out various embodiments. A data management system 202 in communication with a synthetic data generation user interface 204 receives source data from a user 206 via the synthetic data generation user interface 204 and/or by accessing data repository 212. The data management system 202 prompts large language model 216 with prompt 214 to generates synthetic data 218 from the source data. Synthetic data 218 and the source data may be stored in data repository 216, which is accessible to data management system 202. Synthetic data 218 may be stored as target data for use in production system 208. The data management system 202 is also in communication with a production system 208, which includes a target model 210. The data management system 202 communicates the target data to the production system 208 for use in training the target model 210.

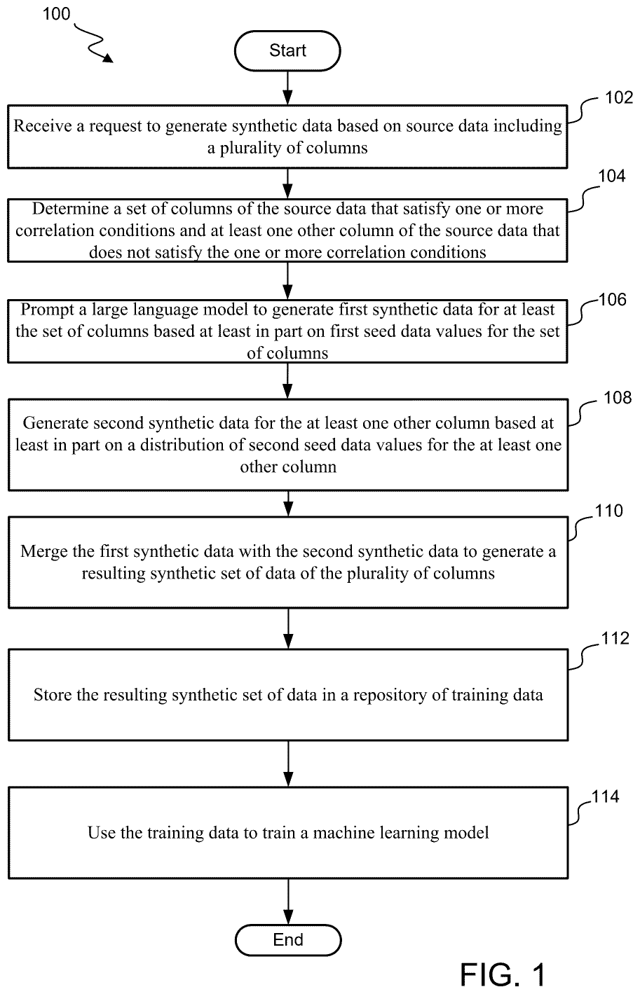

FIG. 1 depicts a flowchart of a process 100 for generating synthetic data. At block 102, the data management system receives a request to generate synthetic data based on source data including a plurality of columns. At block 104, the data management system determines a set of columns of the source data that satisfy one or more correlation conditions and at least one other column of the source data that does not satisfy the one or more correlation conditions. At block 106, the data management system prompts a large language model to generate first synthetic data for at least the set of columns based at least in part on first source data values for the set of columns. At block 108, the data management system generates second synthetic data for the at least one other column based at least in part on a distribution of second source data values for the at least one other column. At block 110, the data management system merges the first synthetic data with the second synthetic data to generate a resulting synthetic set of data of the plurality of columns. At block 112, the data management system stores the resulting synthetic set of data in a repository of training data. At block 114, the data management system uses the training data to train a machine learning model.

A user interface of the data management system allows a user to specify a set of source data to be used as a template for generating synthetic data. The data is stored in a tabular or other structured form in a structured document, such as a CSV, XML, or JSON file, and has a plurality of columns. The user inputs the data to the data management system or directs the data management system to a location in the data repository where the data is already stored. The data may be referenced or identified using a structured path to the data in the data repository, and the structured path may be based on a portion of a hierarchy of data that is covered by the source data. The data management system may provide options, via a data management user interface, to input pre-processing settings, correlation guidelines, and/or data generation settings.

The pre-processing settings may include settings to filter out subsets of data that match data value patterns or regular expressions chosen by the user, and to optionally substitute other values from synthetic data dictionaries of values associated with those regular expressions. For example, a pre-processing setting may allow the user to select data value patterns or regular expressions for personally identifiable information (PII) and substitute other values from synthetic data dictionaries of names, phone numbers, or addresses. The source data may be pre-processed according to the pre-processing settings immediately upon receiving the source data and the pre-processing settings, or at a later time after the data is stored and retrieved in preparation for a synthetic data generation process.

The correlation guidelines correspond to the correlations between columns of the source data that may be specified by the user via the data management user interface, automatically detected by the data management system, or overridden by the user via the data management user interface. In one embodiment, the data management user interface receives input specifying the correlation guidelines by selecting columns of the data on a graphical display and inputting manually specified correlations that the user has determined exist between the columns or confirmed or overridden correlations that the data management system determined exist between the columns. The correlation guidelines may also include a strength of correlation score for each correlation identified by the user. In an alternative embodiment, the user may input the correlation guidelines in natural language format, describing correlations the user has observed between the columns.

In another embodiment, the correlation guidelines may be one or more correlation thresholds that, if compared with data within the source data's columns, will determine if a correlation exists between columns. The correlation threshold(s) as adjustable by the user may determine whether observed correlation between existing data columns is sufficient to qualify the columns as correlated or not. For example, the correlation threshold may be set at 0.6, such that the contents of the columns are considered correlated if the Pearson correlation coefficient between the columns is greater than or equal to 0.6.

The data management system may also prompt the user to input non-correlation data, corresponding to columns without correlations to other columns. The user may input the non-correlation data by selecting columns of the data on a graphical user interface to denote columns without correlations to other columns. In an alternative embodiment, the user may input the non-correlation data in natural language format, describing which columns the user has observed to not have correlations with other columns.

The data management system, upon receiving the correlation guidelines, may determine if the correlation guidelines are to be parsed to determine if a correlation condition is met between columns. In one embodiment, synthetic data generation settings indicate that correlation is automatically determined without correlation guidelines. In another embodiment, synthetic data generation settings indicate that the correlation guidelines determine how the synthetic data is generated and may be used in prompting a large language model to generate synthetic data.

Some correlation data may be used directly to determine if a correlation condition is met, such as correlation flags set by the user, however, some correlation data, such as correlation thresholds or correlation strengths entered by the user, may first be compared to the data within the source data's columns or with pre-determined correlation thresholds to determine if a correlation condition has been met. For example, the user may specify a correlation exists between two columns for which the system cannot detect a correlation. In this embodiment, depending on the synthetic data generation settings, the data management system may override the user indication that the columns are correlated and treat the columns as uncorrelated, or may prompt a large language model to generate synthetic data for the columns without providing guidelines to the large language model about how the columns are correlated.

The data generation settings may include range format according to data range dictionaries, the number of rows or data to be generated, selection of source data to use, whether any data of the source data may appear in the final synthetic data, whether any data of the source data should appear in the final synthetic data, and the columns of the source data from which data should or may appear in the final synthetic data. Data generation settings may be saved and used again for future data generation instances.

The data management system, upon receiving the source data, correlation guidelines, and/or data generation settings, generates synthetic data according to synthetic data generation settings. The method of data generation for any column depends upon whether the determination has been made that column satisfies a correlation condition or not. For columns that satisfy a correlation condition, a default mode of generating data may be used by generating a prompt based on the synthetic data generation settings. The prompt may include synthetic data generation guidelines and/or examples of the source data, as well as an instruction on what format to provide resulting target data. The prompt is sent to a large language model to generate data based on examples of the source data. For columns that do not satisfy a correlation condition, a default mode of generating data may be performed based on a sampling of the source data.

After generating the synthetic data for each column of the source data, the data management system merges all the stored generated data into target data. When merging the stored generated data, new data values are stored in columns of the source data based on the data generated by the LLM for each column and returned to the data management system in the specified format.

The target data may then be evaluated and post-processed such as to evaluate the similarity to the source data or to remove unwanted data. Evaluation of target data may be performed based upon inputs by a user in a synthetic data review interface, and/or by automatically verifying that the synthetic data conforms to a format requested from the LLM and available for storage in logical storage containers of the data repository. For example, the logical storage containers may include data type restrictions that are checked based on the resulting data provided by the LLM to confirm that the data conforms to the data type restrictions prior to storage.

After generation of the target data and any optional evaluation or post-processing, the target data may then be incorporated into a production system such as by training a target model to make predictions about missing data, make corrections to provided data, and/or predict future data values.

To train the target model, the target data provided by the LLM may be divided into training data and validation data, and used to train a new model or tune an existing model as well as validate that the trained or tuned model satisfies performance criteria.

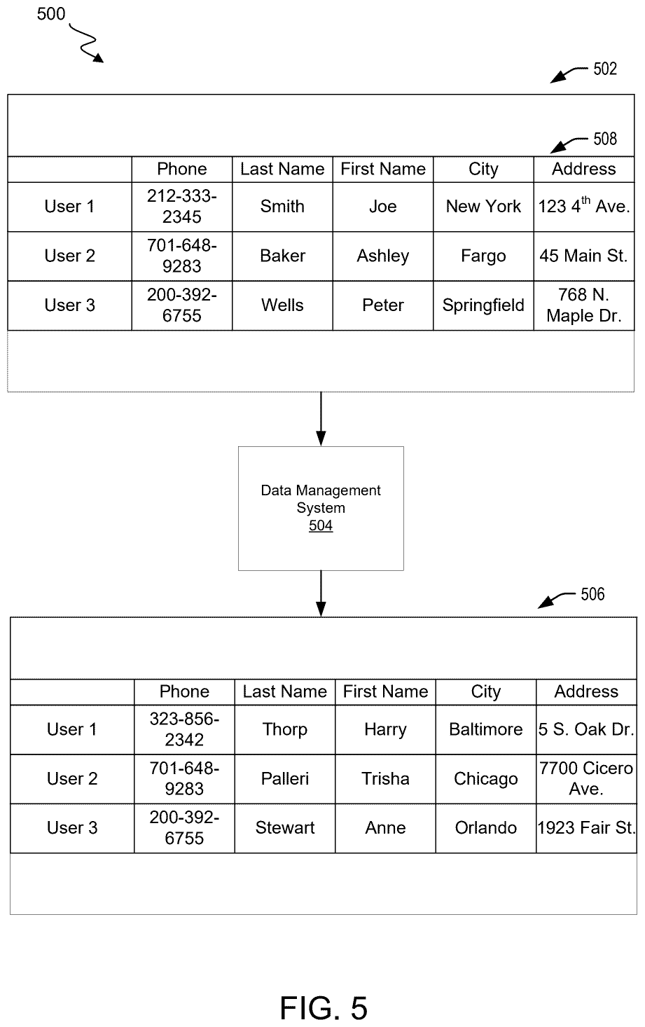

An example system 500 is depicted in FIG. 5, where the source data 502 is provided to the data management system 504, which outputs the target data 506. The source data 502 includes a plurality of columns 508 within which the source data is organized. The target data 506 maintains the same plurality of columns as the source data 502, within which the target data 506 is organized.

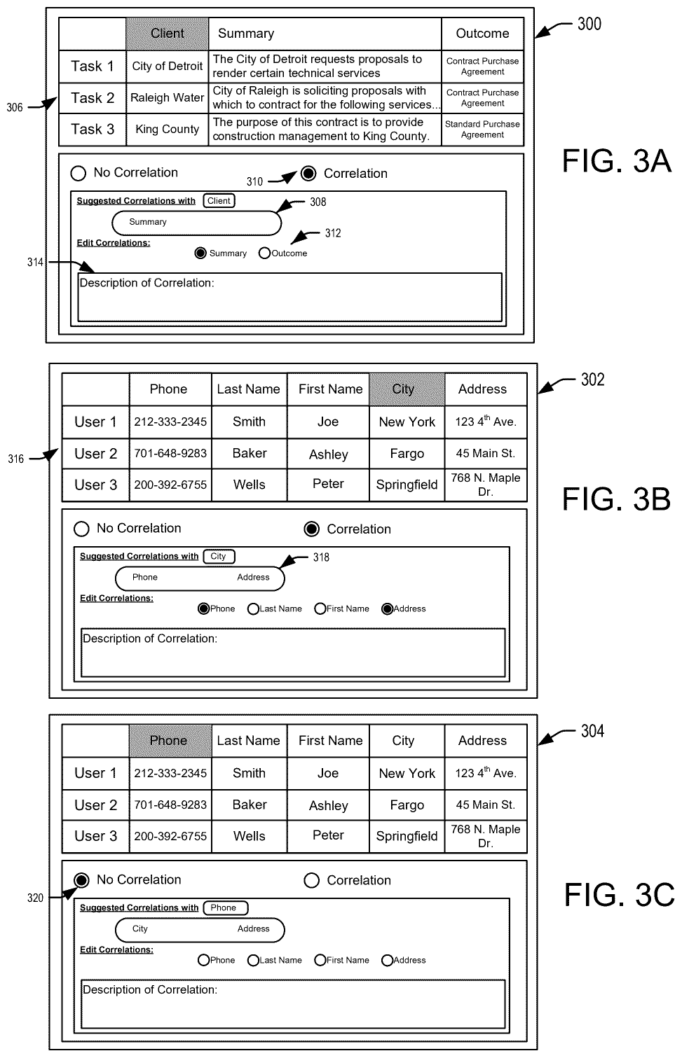

FIG. 3A depicts an example user interface 300 for inputting a set of target data 306. The data management system may then determine correlated columns and present the detected correlation to the user, such as by a correlation suggestion 308. The user interface 300 provides an option for the user to elect whether to use the detected correlation by a correlation election interface 310. The correlation between columns may also be edited by a correlation editing interface 312. The user may provide correlation guidelines 314 for describing correlations, such as in a way that can be consumed by an LLM when generating synthetic data. FIG. 3B depicts another example user interface 302 for inputting a set of target data 316. FIG. 3B particularly depicts an example of a tuple 318 of columns correlated or potentially correlated with a City column under analysis as well as with each other. FIG. 3C depicts another example user interface 304, particularly depicting a user election 320 to disregard the suggested correlation.

### Automatically Determining Correlations

In the case that correlation data is not entered by the user or that an automated correlation suggestion is requested pursuant to synthetic data generation settings, the data management system may determine correlations between the columns by calculating a similarity measure to be compared to a threshold value. For numerical or vector data, the data management system may use any distance function or other method of determinations of numerical or vector similarities, such as Cosine Distance, the Euclidean Distance, the Pearson Correlation Coefficient, the Manhattan Distance, the Minkowski Distance, the Hamming Distance, the Chebyshev Distance, the Jaccard Distance, the Sorensen-Dice Distance, the Pearson correlation coefficient, or any other means of calculating correlation. For text data, the correlation may be determined by first converting the text to embeddings in vector space in a large language model, which can then be compared using any of the above methods for determining the similarity between vectors. The text embeddings may reduce semantic meanings within the text to numerical values corresponding to the detected semantic meanings. In this way, the correlation between columns is based on the meanings of the words of the text data.

The distance or similarity analysis may be performed on the whole vector embedding or by breaking up vectors into components to determine correlation of corresponding components across the vectors. For example, a first vector and a second vector may each include a component that indicates an area code of a phone number, and the area codes may be correlated across vectors even though the rest of the phone number is not correlated. The column correlation may be determined by comparing the correlation determined according to as the similarity measure to a correlation threshold as a correlation criterion. The columns may be counted as correlated if the correlation measure exceeds the correlation threshold. In an alternative embodiment, the columns may be compared to determine correlation clusters, where columns are determined to be part of a cluster if the correlation between all combinations of columns in the cluster is above a certain threshold.

A Pearson Correlation Coefficient between two vectors is calculated as a ratio between the covariance between the vectors and the product of the standard deviations between the two vectors. A correlation coefficient of 1 represents identical vectors, a correlation coefficient of −1 represents opposite vectors, and a correlation coefficient of 0 represents vectors that are not correlated.

A Cosine Distance or cosine similarity between two vectors is determined by calculating a cosine of the angle between the two vectors. A result of 1 represents a cosine similarity between two identical, a result of −1 represents a cosine similarity between two opposite vectors, and a result of 0 represents a cosine similarity between two unrelated or orthogonal vectors.

A Euclidean Distance is determined by calculating a square root of a sum of the squares of the distances between components of the two vectors. The higher the Euclidean distance, the lower the similarity between the components of the vectors used in the calculation.

A Manhattan Distance is calculated as a sum of the absolute differences between components of the vectors. The higher the Manhattan Distance, the lower the similarity between the components of the vectors used in the calculation.

A Minkowski Distance is calculated as the p-th root of the sum of the absolute differences between components of the vectors raised to a power, p, for each component pair. The Minkowski Distance equals the Manhattan Distance when p=1 and the Euclidean Distance when p=2. The higher the Minkowski Distance, the lower the similarity between the components of the vectors used in the calculation.

A Hamming Distance between two vectors is determined based on how many positions at which corresponding components of the vectors are different or sufficiently different. For each component pair in the vectors that are different, a counter is incremented. The Hamming Distance is the total counter for the vectors across all component pairs.

A Chebyshev Distance between two vectors is calculated as the greatest of the absolute differences among the vectors' corresponding components. The largest absolute difference among all the pairs of components is the Chebyshev Distance. The larger the Chebyshev Distance, the lower the similarity between the vectors.

A Jaccard Distance between two vectors is calculated as a ratio between the size of the intersection between the vectors (based on elements in common between the vectors) to the size of the union between the vectors (based on elements in either or both of the vectors). Jaccard Similarity is defined by the ratio, and Jaccard Distance is defined as one minus the Jaccard Similarity.

The Sorensen-Dice Similarity is calculated as two times the number of elements in common among the vectors divided by the sum of the number of elements in each vector. The Sorensen-Dice Distance is one minus the Sorensen-Dice Similarity.

In one embodiment, the data management system determines correlations between a value or roll-up value of a first dimension and a value or roll-up value of a second dimension. For example, a particular city of a location dimension may be referenced from a company record, and a correlation may be determined based on a rolled up state, country, or region value from the location dimension and a company description value of the company record, even though the rolled up state, country, or region value is not directly referenced by the company record.

For any determinations of correlation, the data management system may prompt the user to approve or edit detected correlations by displaying the detected correlations to the user. In the case that the correlation criteria is a single threshold value, the user may be prompted to approve or reject correlations determined to be above the threshold, or to add correlations that were not determined to be above the threshold. In the case that the correlation criteria is for clustered correlations of columns, the determined correlation clusters may be displayed and the user prompted to approve or reject correlations or to edit clusters by moving columns to other clusters or removing them entirely from any clusters.

Some synthetic data generation settings data may be interpreted into prompt language that will be understood by a large language model. The interpretation of data generation settings may depend upon the means by which synthetic data generation settings are entered. Synthetic data generation settings may be entered by selecting pre-determined options within a graphical user interface over the source data provided by the user. Pre-determined options may correspond to additional language to be added to a prompt that is modified based on the user's input of the synthetic data generation settings. For example, the data management system may, after receiving the source data, display the source data in a graphical user interface for the user to select a number of columns for which none of the source data should appear in the final synthetic data. For each column that the user selects in the graphical user interface to not appear in the final synthetic data, the data management system, when generating data for those columns, includes within the prompt the additional language: “Generate new values for the [column] field that do not match any of the provided examples.”

Synthetic data generation settings may also be entered in natural language format, in which case the data management system may pass the natural language data generation settings on to the prompt directly or may parse the natural language data generation settings to determine additional language to add to the prompts to represent the synthetic data generation settings. When passing the natural language synthetic data generation settings to the large language model prompt, the natural language synthetic data generation settings may still require additional language to properly direct the prompt. For example, the synthetic data generation settings may contain the natural language parameter: “include half of the provided examples in the results.” The data management system may parse this natural language parameter to determine that this is an additional requirement to add to the prompt, in which case the natural language parameter is appended to the prompt with the addition of any connecting or prefix words required for understanding the relation to the rest of the prompt. As an example, the data management system may determine that one or more parameters within the synthetic data generation settings are limitations for the final synthetic data, in which case the parameters are added as a list, preceded by the words “here are output format requirements:”.

### Generating Synthetic Data for Correlated Columns

Correlated columns are determined at least in part by satisfying a correlation condition. A correlation condition may be satisfied for any plurality of columns. There may be multiple correlations between columns of the source data. Data is generated for correlated columns in a connected or dependent way that maintains the correlation between the data of each column. In a simplified example, there are five columns, where the first and second columns are correlated, the third and fourth columns are correlated, and the fifth column is not correlated to any other column. For this example, data for the first and second columns are generated concurrently or dependently, data for the third and fourth columns are generated together or dependently, and data for the fifth column is generated separately.

To generate data that maintains a correlation between columns, data for the correlated columns is generated using a large language model that is prompted to maintain the correlation. The data may be generated concurrently, in which case the large language model is prompted to generate data of both columns and is prompted with the correlation determined between the columns. In an alternative embodiment, data may be generated dependently, in which case data is generated for a first correlated column, then data is generated for a second correlated column by prompting a large language model with the data generated for the first correlated column and the correlation between the columns. This may be performed consecutively for further correlated columns by prompting a large language model with the previously generated data of correlated columns and the correlation to the column to be generated. In an alternative embodiment, the data for further correlated columns may be generated concurrently by prompting a large language model with the generated data of the first correlated column and the correlation for each of the remaining correlated columns.

Correlations and observed relationships included within the prompt to generate any correlated data may include any combination of examples of the correlation data, observed relationships, or data generation settings entered by the user. For example, the data management system may determine that two columns are correlated such that a first column is always within a 5% variance of a second column. In this example, a large language model may be prompted: “Generate a new set of examples similar to the examples below and maintain [first column] within a 5% variance of [second column] Example 1 {Input: 50 Output: 49}Example 2 {Input: 100 Output: 105}.” In another example, the data management system may observe a relationship that a first and second column contain 50% of the same words in each row, and the data generation settings may indicate that no words of the source data should appear in the generated data. In this example, a large language model is prompted: “Generate a new set of examples similar to the examples below but with new values for the A and B fields Example 1 {A: cow horse dog cat B: dog cat fish goat}Example 2 {A: car house street mailbox B: street mailbox tree shed}.” Based on the examples, the LLM may generate synthetic data such as {A: truck hamster taco container B: taco container shark road}.

There may be a correlation and one or more observed relationships between columns. In the case that observed relationships exist between columns of a group, the observed relationships may be passed to the large language model together with an indication that the columns are correlated when generating data for the correlated columns. For example, two columns containing data in a string format may have a first observed relationship that at least one noun appears in data of the same row of both columns. The two columns may have a second observed relationship that the second column contains one or more synonyms for at least one word in the first column. In this example, a large language model is prompted: “Generate a set of examples similar to the examples below and include at least one of the same noun in both the A and B fields and include in the B field synonyms of at least one word in the A field.”

In the case that observed relationships or correlations overlap, that is, each observed relationship or correlation relates a different set of columns with at least one column overlapping between any two correlations, the data for all the columns correlated by at least one of the overlapping correlations may be generated concurrently or dependently by the LLM using examples from all of the columns. The columns with overlapping correlations may each be included within the prompt given to the large language model for concurrently generating all the data for the columns with overlapping correlations. In an alternative embodiment, the overlapping correlations may be parsed by analyzing the correlation data to determine a dependency or hierarchy of the correlations, in particular based upon whether each correlation is biconditional. For example, for a first, second, and third column, there may be an overlapping correlation or observed relationship where the first and second columns each contain a minimum amount of the same words. The third column may have an observed relationship to the second column in that the third column contains synonyms of one or more words in the second column. In this example, the synthetic data generation method may detect that the correlation or observed relationship between the third and second column is secondary to or depends on the correlation or observed relationship between the first and second column as the correlation between the second and third column is conditional, or only affects the generated values for the third column. A prompt may then be input into a large language model to generate synthetic data for the first and second column based on the correlation between those two columns. The data generated for the first and second columns may then be included in a new prompt given to the large language model to generate synthetic data for the third column, based on the correlation between the second and third column.

In one embodiment, multidimensional data may be generated by including, in the prompt, one or more values related to a dimension, such as values from a record, and one or more values related to a roll-up of another dimension that is referenced in the record, even though the roll-up value itself is not referenced in the record. For example, a record such as a store inventory record may reference a particular object in an object dimension using a key value for the particular object. A detail in the store inventory record, such as a shelf name, may be correlated with a particular roll-up value for the particular object, such as an object type. Even if the object type is not referenced in the store inventory record, the data management system may detect a correlation between the shelf name and the object type. For example, if the object type is “cord” and the shelf name is “cables and accessories,” the data management system may detect a correlation that indicates objects of type “cord” are often stored on a shelf named “cables and accessories.” In this scenario, the data management system may supplement the large language model with roll-up data from another dimension when asking the large language model to generate synthetic data. For example, the supplemented data may include the object type and the shelf name even though no single record in no single dimension has both the object type and the shelf name directly referenced by the record. As a result, the large language model may generate data that complies with the object type and shelf name correlation.

In one embodiment, the data management system supplements the prompt to the large language model not only with example data values but also with existing ranges of data values from one or more existing dimensions. For example, the data management system may supplement the prompt by providing, to the LLM, a list of objects corresponding to the object type that is correlated with the shelf name and a list of other objects corresponding to other object types that may be correlated with other shelf names. GENERATING THE LARGE LANGUAGE MODEL PROMPT

The data management system generates a text-based prompt to use with a large language model to create synthetic data that respects correlations. The prompt generally includes three components: 1) the type of request, 2) the examples to be used from the source data, and 3) the data generation settings for the generation of results. The words that make up the type of request can be of any format that relates to the examples and data generation settings used. The prompt may be generated by including each element of the prompt within a set prompt format, including punctuation to delineate the request, example data, and any data generation settings. The type of request language may be a set phrase that is appended to each prompt generated. As an example, the type of request language may include “generate a new set of data similar to the examples below” or “above” or “create new rows of data with the same format as the below examples” or “above examples.” The example data should be formatted in a way that the large language model can parse the delineation of each data row from other rows and each data column from other columns. As an example, the example data may be formatted as “Example 1 {Column_1: Data_1 Column_2: Data_2}, Example 2 . . . ” The data generation settings may be appended anywhere within the prompt. For example, the data generation settings may appear before or after the type of request language or before or after the final example.

In one example, a configuration command may be provided to the data management system in a session or connection of the user to select a particular large language model for use with generating synthetic data for the user. In one example, the “openai” large language model provider is chosen with named credentials. The model used may be, for example, gpt-3.5-turbo. Other example providers include, but are not limited to, Cohere, Azure AI, Google PaLM 2, etc. In various other examples, default credentials may be used by the data management system. In one embodiment, the credentials include user-specific credentials, such as a user-specific LLM session identifier, that allow the LLM service to switch between supporting different users within the same LLM session using the same LLM connection credentials. In this embodiment, context from a given user may be retrieved using the LLM session identifier before processing the prompt for synthetic data generation for the user.

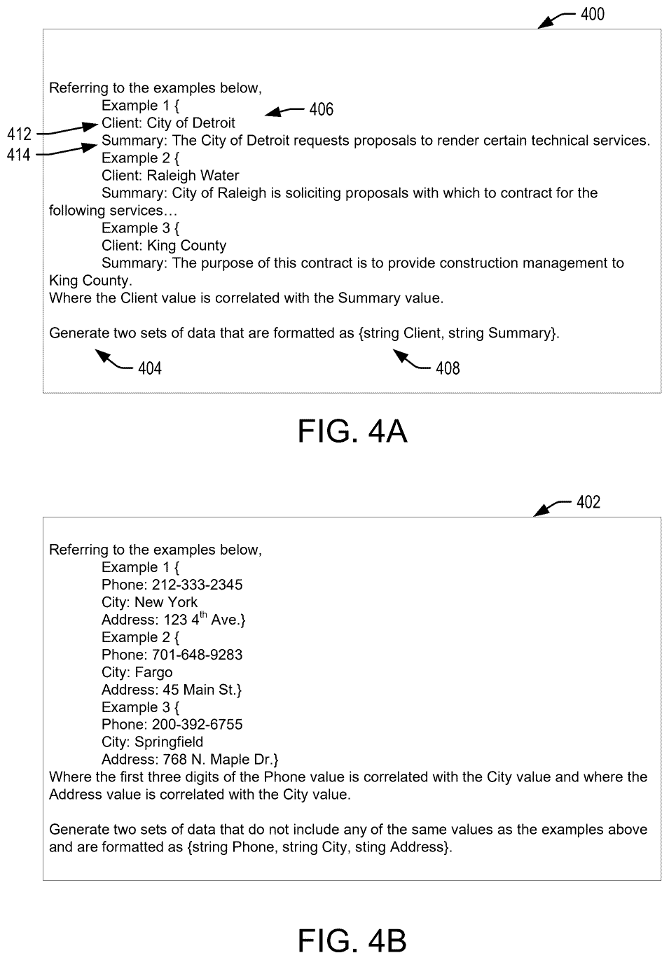

FIG. 4A depicts an example of a prompt 400 generated for passing to a large language model, based on the source data 306. The prompt 400 includes a request 404, examples 406, generation settings 408, and correlation guidelines 410. Each example comprises a first column data 412 and a second column data 414. FIG. 4B depicts another example prompt 402 generated for passing to a large language model, based on the source data 316.

The number of examples given in a single prompt may be limited by the total allowable data for a prompt of the large language model used. As the type of request language and the data generation settings are of set text lengths, the number of examples given is the simplest to vary to reduce the total data of the prompt to fit within a requirement. To determine a maximum prompt size, the data management system may generate a prompt with the type of request and data generation settings language, as well as a number of examples from the source data, up to the total number of examples within the source data. If the large language model returns an error indicating that the prompt is too large, the data management system may reduce the number of examples within the prompt and try the prompt again with the large language model. This process can be repeated until the large language model accepts the prompt size, at which point the data management system may record the maximum number of examples within the maximum prompt size and determine a number of data to generate for each grouping of examples such that the required synthetic data is generated while using as much of the source data as possible to maximize diversity of the output synthetic data.

In one embodiment, to promote diversity of the output synthetic data, the number of data generated by any one prompt is less than or equal to the number of source data provided within that prompt. For generating synthetic data from large source datasets, diversity of synthetic data generated may be improved by using multiple prompts and selecting a smaller number of source data to use in each prompt. The source data may be selected as a random subset of the source data, and the random subsets used may be varied or may overlap across different prompts. In one example, to improve diversity of generated synthetic data, the data management system may record which source data has already been used in previous prompts, so as to only use unused source data. The system may use different rows of the source data in different prompts, optionally using each row one or more times to improve diversity of generated synthetic data.

The data management system may also aim to reduce usage of the large language model for cost savings. In this case, a larger number of output data may be requested in each prompt and group of example data. In the case that the number of prompts the data management system is able to use is limited.

In one embodiment, in the case that the number of requested data items is less than the total source data items divided by the maximum example data size, the source data may be analyzed by a correlation method to determine clusters of similar example data to promote high quality insights by the LLM. The data management system may then record which clusters of example data the example data of each prompt belongs to, in order to sample data from different example data clusters with each prompt to further improve diversity of generated synthetic data.

### Generating Data for Non-Correlated Columns

For a column where a correlation to another column has not been determined or entered by the user, the generation of the target data by the data management system may be performed independently for each column. To generate target data for a non-correlated column, the data management system may first determine if there is a data generation setting corresponding to the generation of non-correlated column data. Such a data generation setting may include whether to generate non-correlated data by sampling from the source data or by generating from a range or dictionary of data. In the absence of a data generation setting directing the method of generating non-correlated column data, the data management system may, by default, generate data by sampling from the source data.

In the case that non-correlated column data is to be generated by sampling from the source data, the sampling may be performed by any sampling algorithm. The data management system may randomly sample data, such as by using a pseudo-random algorithm.

Different random sampling techniques are available for preserving the original distribution of data from the source data, which may be requested for the data generation task. In an alternative embodiment, the source data may be sampled randomly along the frequency distribution of the source data, such that values appear in the target data with approximately the same frequency with which they appear in the source data. In another alternative embodiment, the source data may be sampled by dividing the values into multiple sub-ranges and assign a probability to each of the sub-ranges. The system then randomly determines a sub-range based on the probabilities of each sub-range and picks a random value within the chosen sub-range. In another alternative embodiment, the source data may be sampled via a neural network for sampling data such as a Generative Adversarial Network. In a particular embodiment, the data management system may use CTGAN, which uses deep learning to synthetically generate data for a table by sampling the data according to an input distribution.

In an alternative embodiment, the user may elect to sample from a data range or dictionary relating to the column of source data. There may be a plurality of value range templates used for matching the data of each non-correlated data column. The user may be presented with a list of value range templates for each column of the source data such that the user may select which value range template to use for each column such that the data are treated in accordance with the value range template and differently than random, discrete values. In an alternative embodiment, each value range template checks one or more values within the column of the source data. If a value range template matches values within the column of the source data, the values may be treated in accordance with the value range template and differently than random, discrete values. In an alternative embodiment, the data management system may present the detected value range template to the user, optionally with the detected matching values, for the user to approve of the use of the value range template such that the data within that column are treated in accordance with the value range template and differently than random, discrete values. In the case that automatic matching of value range templates is used, the user may still be prompted with the results such that the user may not only elect whether any detected value range templates should be used, but also whether to use any value range templates for columns where the no matching template was detected.

In one example, one of the value range templates may check for a phone number formatting, using a regular expression of ###-###-####, or by checking for a seven, ten, or eleven-digit number. If a phone number value range template is used for generating synthetic data, the user may be prompted to elect which format of possible phone number formats should be used. Data for the phone number format column may be generated by random sampling from a dictionary of numbers in a phone number format, or by random sampling from the total range of seven, ten, or eleven-digit numbers. Another value range template may check for a social security number, using a regular expression of ###-##-####, or by checking for a nine-digit number. If a social security value range template is used for generating synthetic data, data for the column may be generated by random sampling from a dictionary of numbers in the social security format, or by random sampling from the total range of nine-digit numbers.

Yet another value range template may check for names by first checking that the column contains only alphabetical characters where each word begins with a capital letter, then checking that a threshold number and/or percentage of values are in a dictionary of names. There may be multiple value range templates defined for a variety of name categories, for example a value range template of female names, common names for a given region, or names of cities. If a name value range template is used, data for the column may be generated by randomly sampling from a dictionary of names. Another value range template may check for addresses by first checking that the column contains alphanumeric text where numbers appear before strings of alphabetical characters and a threshold number or percentage of the values end in an address suffix from an address suffix dictionary, such as St., Rd., Ave., Street, Road, or Avenue. If an address value range template is used, data for the column may be generated by randomly sampling from a dictionary of addresses.

One of the templates may check for a continuous range of numerical values. The system may first determine if the values in the source data values are numerical. For a column of numerical values, the system may determine if there are few exact overlaps within the source data values. The system may then determine bounds of the range, such as an upper and lower limit. The continuous range of numerical values template may then be presented to the user with the bounds of the range. If such a template is used for generating values, the data management system may generate values from any point within the range, optionally following a distribution over the range determined by analysis of the source data.

In an alternative embodiment, the user may, without election of a specific value range template, define a range of values from which to sample, optionally with a defined value formatting. The user may, for example, define that a given column is a range of positive decimals from zero to one hundred. The user may also define a probability distribution to use when sampling from the defined range, such as by entering a function representing the probability distribution. The data management system may, upon receiving the user's defined range and optional formatting or probability distribution, generate synthetic data for the column by randomly sample values from the range in accordance with the formatting or probability distribution.

### Validation of Synthetic Data

The data management system, after generation of synthetic data, may evaluate the similarity between the target data and the source data and/or whether the target data satisfies format requirements specified by the synthetic data generation settings or implemented by the data repository where the target data is to be stored. The evaluation of similarity between the target and source data may use any of the similarity methods detailed above, where numerical values are evaluated by a distance algorithm and text values are evaluated by first converting the text to vector embeddings in a large language model and comparing the resulting vectors by some distance algorithm. The data management system may compare the similarity score of the target data to a threshold value and generate new values for the target data for any data sets where the similarity score is lower than a threshold value. If the values are generated using a large language model, the sets of values may be entered as an example of an improper output, along with the generated data of correlated columns, prior data generation settings, and examples of proper data. For values of correlated columns of a value that is determined to be insufficiently similar, the data management system may generate new values, if the correlation to the column with the invalid data is biconditional.

The data management system may also evaluate the validity of the final synthetic data with one or more data type restrictions. An example data type restriction may be if a format has been determined prior to generation of synthetic data, such as by detection or election of a value range template or by other, prior detection of formatting, the target data may be evaluated by comparison to the formatting. As an example, for one column the data management system may have detected a phone number value range template, and the user may have elected a formatting of seven-digit numbers. An evaluation of the validity of the data may determine that some rows of target data are invalid as they contain only six-digit numbers. For any data that is determined to be invalid, the data management system may generated new values. If the values are generated using a large language model, the previous value may be entered as an example of an improper output, along with the generated data of correlated columns, prior data generation settings, and examples of proper data. For values of correlated columns of a value that is determined to be invalid, the data management system may generate new values, if the correlation to the column with the invalid data is biconditional.

The data management system may display the target data to the user for approval. The user may then approve or reject target data, such as by marking certain rows or values as good or bad results. The data management system may generate new values for the rejected target data, using the same method of generation for each column of rejected target data. For data of columns previously generated by a large language model, the data management system may generate a new prompt, using the same data generation settings, and include in the prompt the rejected data and examples of approved data. The approved data used may be determined by a similarity analysis to determine the closets distance approved values to the rejected values. Optionally, the approved data used may also include a value that is the farthest distance from the closest approved data used in the prompt.

The data management system may also filter out target data for possible known issues. In one example, the data management system may search the target data for keywords of undesired text, such as profanity or other offensive or sensitive language. In another example, the data management system may pass the target data to a machine learning model trained to detect sentiments within the text. In this example, the data management system may search the detected sentiments for undesired sentiments or text meanings, such as inherent bias.

The data management system may also perform a variety of data quality analyses on the target data. One example of a data quality analysis is a calculation of variance in output. To determine a variance in output, a similarity analysis may be performed between target data to determine a distance between data. The distances may be compared to a threshold value, and new target data may be generated if a minimum number of distances are not greater than the threshold. Another example of a data quality analysis is analysis of variance in words for text data. Variance in text data may be performed by converting the text data into embeddings and measuring distance between the embeddings. In an alternative embodiment, variance in text data may be determined by traversing the text of the target data and scoring words of a dictionary for frequency of use.

Another example of a data quality analysis is checking data for duplication of source data. In this example, the target data may be directly compared to the source data to determine exact duplicate values. In an alternative implementation, checking for duplication of source data may be performed by a distance analysis to determine that the distance from all source data is of a minimum threshold distance. Detection of duplication of source data may be performed on individual values or columns, or across a set of columns or values.

For all types of post-generation analysis, analysis of correlated target data may be performed after generation and before merging with other generated target data. For generated target data that is rejected under one or more data quality analyses, the target data may be replaced by re-running the same prompt with the large language model. Alternatively, the prompt may be edited or a new prompt generated to add the rejected data as a negative example of output data, with optional language identifying the characteristic of the data by which it was rejected.

### Application of Synthetic Data

The data management system stores target data in association with the column or columns the data relates to. The data management system tracks, such as via the stored target data, which columns target data has been generated for. After confirmation that the required amount of data has been generated for each column of the source data, the data management system merges the target data into a final target data, for example, with the same columns as the source data or a subset of the source data columns, depending on the synthetic data requested.

In one embodiment, the large language model is prompted to generate data for multiple dimensions that are not stored or referenced by a same record or object in the data management system. In this embodiment, the large language model may perform one or more roll-up operations on the results of the large language model to determine which values to assign to which dimensions. For example, if a large language model generates synthetic data for a shelf name, and object, and an object type, the data management system may store the shelf name in a store inventory record, update a reference to the object from the store inventory record to an object dimension, and update a reference in the object dimension to the store inventory record. As the object is already of the object type in the object dimension, the type of the object referenced already includes the object in the roll-up of the object dimension and might not need any further updating even if the object type was used in the prompt to generate the synthetic data.

### Computer System Architecture

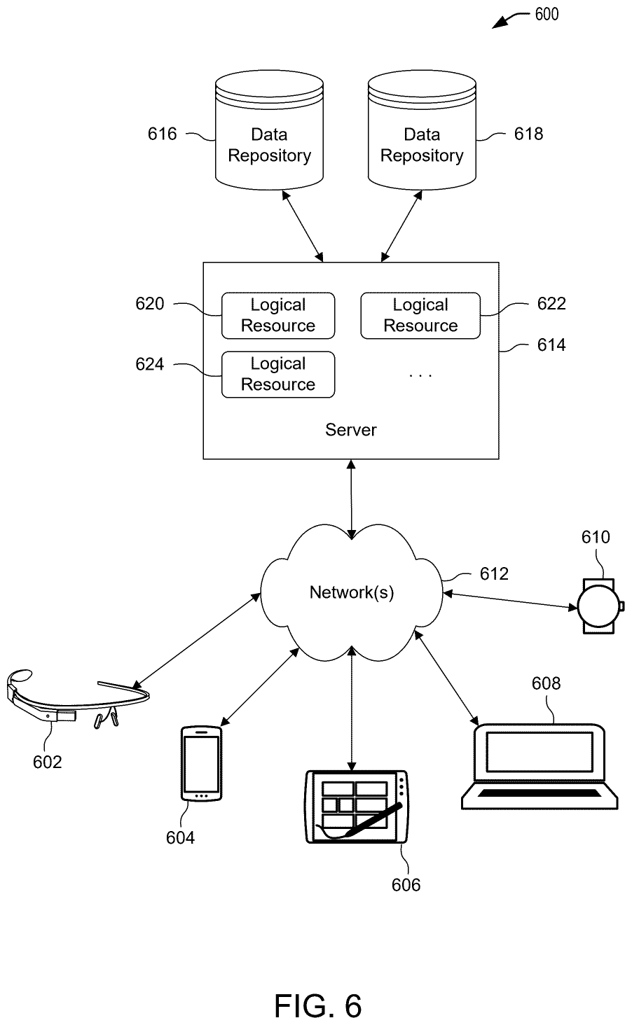

FIG. 6 depicts a simplified diagram of a distributed system 600 for implementing an embodiment. In the illustrated embodiment, distributed system 600 includes one or more client computing devices 602, 604, 606, 608, and/or 610 coupled to a server 614 via one or more communication networks 612. Clients computing devices 602, 604, 606, 608, and/or 610 may be configured to execute one or more applications.

In various aspects, server 614 may be adapted to run one or more services or software applications that enable techniques for data management.

In certain aspects, server 614 may also provide other services or software applications that can include non-virtual and virtual environments. In some aspects, these services may be offered as web-based or cloud services, such as under a Software as a Service (SaaS) model to the users of client computing devices 602, 604, 606, 608, and/or 610. Users operating client computing devices 602, 604, 606, 608, and/or 610 may in turn utilize one or more client applications to interact with server 614 to utilize the services provided by these components.

In the configuration depicted in FIG. 6, server 614 may include one or more components 620, 622 and 624 that implement the functions performed by server 614. These components may include software components that may be executed by one or more processors, hardware components, or combinations thereof. It should be appreciated that various different system configurations are possible, which may be different from distributed system 600. The embodiment shown in FIG. 6 is thus one example of a distributed system for implementing an embodiment system and is not intended to be limiting.

Users may use client computing devices 602, 604, 606, 608, and/or 610 for techniques for data management in accordance with the teachings of this disclosure. A client device may provide an interface that enables a user of the client device to interact with the client device. The client device may also output information to the user via this interface. Although FIG. 6 depicts only five client computing devices, any number of client computing devices may be supported.

The client devices may include various types of computing systems such as smart phones or other portable handheld devices, general purpose computers such as personal computers and laptops, workstation computers, smart watches, smart glasses, or other wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, Apple Watch®, Meta Quest®, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

Network(s) 612 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 612 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 614 may be composed of one or more general purpose computers, specialized server computers (including, by way of example, PC (personal computer) servers, UNIX© servers, mid-range servers, mainframe computers, rack-mounted servers, etc.), server farms, server clusters, a Real Application Cluster (RAC), database servers, or any other appropriate arrangement and/or combination. Server 614 can include one or more virtual machines running virtual operating systems, or other computing architectures involving virtualization such as one or more flexible pools of logical storage devices that can be virtualized to maintain virtual storage devices for the server. In various aspects, server 614 may be adapted to run one or more services or software applications that provide the functionality described in the foregoing disclosure.

The computing systems in server 614 may run one or more operating systems including any of those discussed above, as well as any commercially available server operating system. Server 614 may also run any of a variety of additional server applications and/or mid-tier applications, including HTTP (hypertext transport protocol) servers, FTP (file transfer protocol) servers, CGI (common gateway interface) servers, JAVA© servers, database servers, and the like. Exemplary database servers include without limitation those commercially available from Oracle®, Microsoft®, SAP®, Amazon®, Sybase®, IBM® (International Business Machines), and the like.

In some implementations, server 614 may include one or more applications to analyze and consolidate data feeds and/or event updates received from users of client computing devices 602, 604, 606, 608, and/or 610. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 614 may also include one or more applications to display the data feeds and/or real-time events via one or more display devices of client computing devices 602, 604, 606, 608, and/or 610.

Distributed system 600 may also include one or more data repositories 616, 618. These data repositories may be used to store data and other information in certain aspects. For example, one or more of the data repositories 616, 618 may be used to store information for techniques for data management. Data repositories 616, 618 may reside in a variety of locations. For example, a data repository used by server 614 may be local to server 614 or may be remote from server 614 and in communication with server 614 via a network-based or dedicated connection. Data repositories 616, 618 may be of different types. In certain aspects, a data repository used by server 614 may be a database, for example, a relational database, a container database, an Exadata storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 616, 618 may also be used by applications to store application data. The data repositories used by applications may be of different types such as, for example, a key-value store repository, an object store repository, or a general storage repository supported by a file system.

In one embodiment, server 614 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

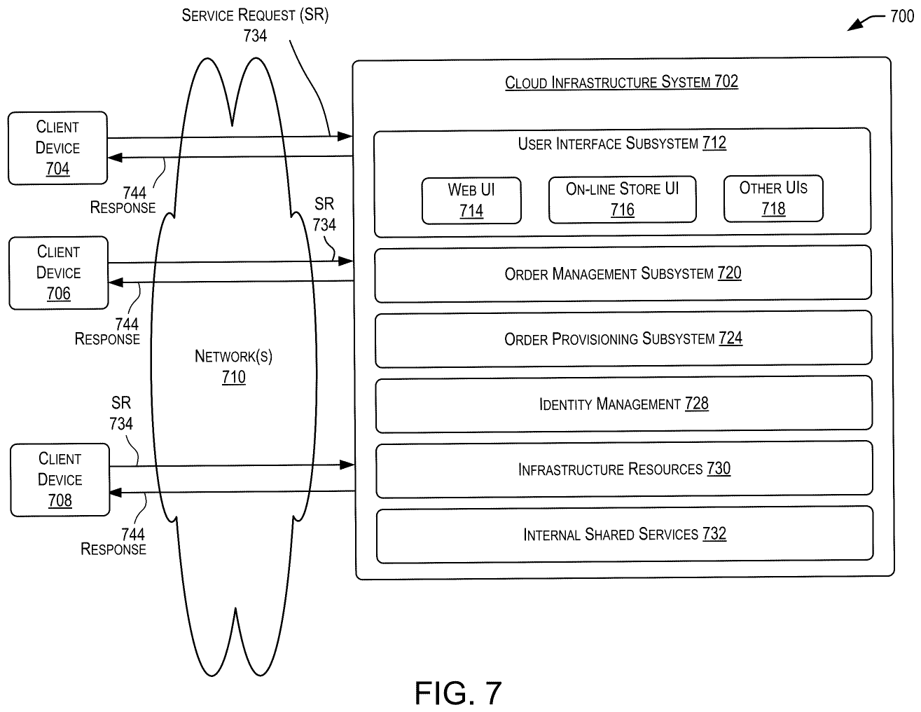

In certain aspects, the techniques for data management. FIG. 7 is a simplified block diagram of a cloud-based system environment in which various text handling-related services may be offered as cloud services, in accordance with certain aspects. In the embodiment depicted in FIG. 7, cloud infrastructure system 702 may provide one or more cloud services that may be requested by users using one or more client computing devices 704, 706, and 708. Cloud infrastructure system 702 may comprise one or more computers and/or servers that may include those described above for server 614. The computers in cloud infrastructure system 702 may be organized as general purpose computers, specialized server computers, server farms, server clusters, or any other appropriate arrangement and/or combination.

Network(s) 710 may facilitate communication and exchange of data between clients 704, 706, and 708 and cloud infrastructure system 702. Network(s) 710 may include one or more networks. The networks may be of the same or different types. Network(s) 710 may support one or more communication protocols, including wired and/or wireless protocols, for facilitating the communications.

The embodiment depicted in FIG. 7 is only one example of a cloud infrastructure system and is not intended to be limiting. It should be appreciated that, in some other aspects, cloud infrastructure system 702 may have more or fewer components than those depicted in FIG. 7, may combine two or more components, or may have a different configuration or arrangement of components. For example, although FIG. 7 depicts three client computing devices, any number of client computing devices may be supported in alternative aspects.

The term cloud service is generally used to refer to a service that is made available to users on demand and via a communication network such as the Internet by systems (e.g., cloud infrastructure system 702) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 710 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation® of Redwood Shores, California, such as database services, middleware services, application services, and others.

In certain aspects, cloud infrastructure system 702 may provide one or more cloud services using different models such as under a Software as a Service (SaaS) model, a Platform as a Service (PaaS) model, an Infrastructure as a Service (IaaS) model, and others, including hybrid service models. Cloud infrastructure system 702 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 702. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

Cloud services are generally provided on an on-demand self-service basis, subscription-based, elastically scalable, reliable, highly available, and secure manner. For example, a tenant, via a subscription order, may order one or more services provided by cloud infrastructure system 702. Cloud infrastructure system 702 then performs processing to provide the services requested in the tenant's subscription order. Cloud infrastructure system 702 may be configured to provide one or even multiple cloud services.

Cloud infrastructure system 702 may provide the cloud services via different deployment models. In a public cloud model, cloud infrastructure system 702 may be owned by a third party cloud services provider and the cloud services are offered to any general public tenant, where the tenant can be an individual or an enterprise. In certain other aspects, under a private cloud model, cloud infrastructure system 702 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 702 and the services provided may be shared by several organizations in a related community. Various other models such as hybrids of the above mentioned models may also be used.

Client computing devices 704, 706, and 708 may be of different types (such as devices 602, 604, 606, and 608 depicted in FIG. 6) and may be capable of operating one or more client applications. A user may use a client device to interact with cloud infrastructure system 702, such as to request a service provided by cloud infrastructure system 702.

In some aspects, the processing performed by cloud infrastructure system 702 for providing Chabot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 702 for determining the intent of an utterance. The data used for this analysis may include structured data (e.g., data stored in a database or structured according to a structured model) and/or unstructured data (e.g., data blobs (binary large objects)).

As depicted in the embodiment in FIG. 7, cloud infrastructure system 702 may include infrastructure resources 730 that are utilized for facilitating the provision of various cloud services offered by cloud infrastructure system 702. Infrastructure resources 730 may include, for example, processing resources, storage or memory resources, networking resources, and the like.

In certain aspects, to facilitate efficient provisioning of these resources for supporting the various cloud services provided by cloud infrastructure system 702 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 702 may itself internally use services 732 that are shared by different components of cloud infrastructure system 702 and which facilitate the provisioning of services by cloud infrastructure system 702. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

Cloud infrastructure system 702 may comprise multiple subsystems. These subsystems may be implemented in software, or hardware, or combinations thereof. As depicted in FIG. 7, the subsystems may include a user interface subsystem 712 that enables users of cloud infrastructure system 702 to interact with cloud infrastructure system 702. User interface subsystem 712 may include various different interfaces such as a web interface 714, an online store interface 716 where cloud services provided by cloud infrastructure system 702 are advertised and are purchasable by a consumer, and other interfaces 718. For example, a tenant may, using a client device, request (service request 734) one or more services provided by cloud infrastructure system 702 using one or more of interfaces 714, 716, and 718. For example, a tenant may access the online store, browse cloud services offered by cloud infrastructure system 702, and place a subscription order for one or more services offered by cloud infrastructure system 702 that the tenant wishes to subscribe to. The service request may include information identifying the tenant and one or more services that the tenant desires to subscribe to. For example, a tenant may place a subscription order for a Chabot related service offered by cloud infrastructure system 702. As part of the order, the tenant may provide information identifying for input (e.g., utterances).

In certain aspects, such as the embodiment depicted in FIG. 7, cloud infrastructure system 702 may comprise an order management subsystem (OMS) 720 that is configured to process the new order. As part of this processing, OMS 720 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 720 may then invoke the order provisioning subsystem (OPS) 724 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 724 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 702 may send a response or notification 744 to the requesting tenant to indicate when the requested service is now ready for use. In some instances, information (e.g., a link) may be sent to the tenant that enables the tenant to start using and availing the benefits of the requested services.

Cloud infrastructure system 702 may provide services to multiple tenants. For each tenant, cloud infrastructure system 702 is responsible for managing information related to one or more subscription orders received from the tenant, maintaining tenant data related to the orders, and providing the requested services to the tenant or clients of the tenant. Cloud infrastructure system 702 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 702 may provide services to multiple tenants in parallel. Cloud infrastructure system 702 may store information for these tenants, including possibly proprietary information. In certain aspects, cloud infrastructure system 702 comprises an identity management subsystem (IMS) 728 that is configured to manage tenant's information and provide the separation of the managed information such that information related to one tenant is not accessible by another tenant. IMS 728 may be configured to provide various security-related services such as identity services, such as information access management, authentication and authorization services, services for managing tenant identities and roles and related capabilities, and the like.

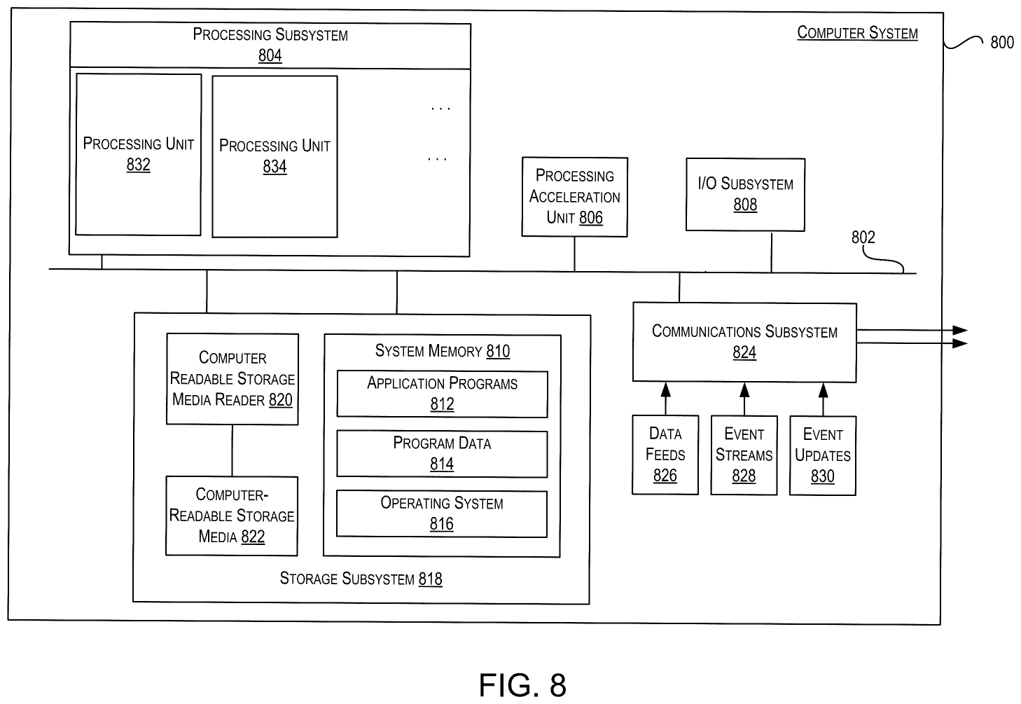

FIG. 8 illustrates an exemplary computer system 800 that may be used to implement certain aspects. For example, in some aspects, computer system 800 may be used to implement any of the system 100 for enriching log records with fields from other log records in structured format as shown in FIG. 1 and various servers and computer systems described above. As shown in FIG. 8, computer system 800 includes various subsystems including a processing subsystem 804 that communicates with a number of other subsystems via a bus subsystem 802. These other subsystems may include a processing acceleration unit 806, an I/O subsystem 808, a storage subsystem 818, and a communications subsystem 824. Storage subsystem 818 may include non-transitory computer-readable storage media including storage media 822 and a system memory 810.

Bus subsystem 802 provides a mechanism for letting the various components and subsystems of computer system 800 communicate with each other as intended. Although bus subsystem 802 is shown schematically as a single bus, alternative aspects of the bus subsystem may utilize multiple buses. Bus subsystem 802 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 804 controls the operation of computer system 800 and may comprise one or more processors, application specific integrated circuits (ASICs), or field programmable gate arrays (FPGAs). The processors may include be single core or multicore processors. The processing resources of computer system 800 can be organized into one or more processing units 832, 834, etc. A processing unit may include one or more processors, one or more cores from the same or different processors, a combination of cores and processors, or other combinations of cores and processors. In some aspects, processing subsystem 804 can include one or more special purpose co-processors such as graphics processors, digital signal processors (DSPs), or the like. In some aspects, some or all of the processing units of processing subsystem 804 can be implemented using customized circuits, such as application specific integrated circuits (ASICs), or field programmable gate arrays (FPGAs).

In some aspects, the processing units in processing subsystem 804 can execute instructions stored in system memory 810 or on computer readable storage media 822. In various aspects, the processing units can execute a variety of programs or code instructions and can maintain multiple concurrently executing programs or processes. At any given time, some or all of the program code to be executed can be resident in system memory 810 and/or on computer-readable storage media 822 including potentially on one or more storage devices. Through suitable programming, processing subsystem 804 can provide various functionalities described above. In instances where computer system 800 is executing one or more virtual machines, one or more processing units may be allocated to each virtual machine.

In certain aspects, a processing acceleration unit 806 may optionally be provided for performing customized processing or for off-loading some of the processing performed by processing subsystem 804 so as to accelerate the overall processing performed by computer system 800.

I/O subsystem 808 may include devices and mechanisms for inputting information to computer system 800 and/or for outputting information from or via computer system 800. In general, use of the term input device is intended to include all possible types of devices and mechanisms for inputting information to computer system 800. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 800 to a user or other computer. User interface output devices may include a display subsystem, indicator lights, or non-visual displays such as audio output devices, etc. The display subsystem may be a cathode ray tube (CRT), a flat-panel device, such as that using a light emitting diode (LED) display, a liquid crystal display (LCD) or plasma display, a projection device, a touch screen, a computer monitor and the like. For example, user interface output devices may include, without limitation, a variety of display devices that visually convey text, graphics, and audio/video information such as monitors, printers, speakers, headphones, automotive navigation systems, plotters, voice output devices, and modems.

Storage subsystem 818 provides a repository or data store for storing information and data that is used by computer system 800. Storage subsystem 818 provides a tangible non-transitory computer-readable storage medium for storing the basic programming and data constructs that provide the functionality of some aspects. Storage subsystem 818 may store software (e.g., programs, code modules, instructions) that when executed by processing subsystem 804 provides the functionality described above. The software may be executed by one or more processing units of processing subsystem 804. Storage subsystem 818 may also provide a repository for storing data used in accordance with the teachings of this disclosure.

Storage subsystem 818 may include one or more non-transitory memory devices, including volatile and non-volatile memory devices. As shown in FIG. 8, storage subsystem 818 includes a system memory 810 and a computer-readable storage media 822. System memory 810 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 800, such as during start-up, may typically be stored in the ROM. The RAM typically contains data and/or program modules that are presently being operated and executed by processing subsystem 804. In some implementations, system memory 810 may include multiple different types of memory, such as static random access memory (SRAM), dynamic random access memory (DRAM), and the like.

By way of example, and not limitation, as depicted in FIG. 8, system memory 810 may load application programs 812 that are being executed, which may include various applications such as Web browsers, mid-tier applications, relational database management systems (RDBMS), etc., program data 814, and an operating system 816. By way of example, operating system 816 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 822 may store programming and data constructs that provide the functionality of some aspects. Computer-readable media 822 may provide storage of computer-readable instructions, data structures, program modules, and other data for computer system 800. Software (programs, code modules, instructions) that, when executed by processing subsystem 804 provides the functionality described above, may be stored in storage subsystem 818. By way of example, computer-readable storage media 822 may include non-volatile memory such as a hard disk drive, a magnetic disk drive, an optical disk drive such as a CD ROM, digital video disc (DVD), a Blu-Ray® disk, or other optical media. Computer-readable storage media 822 may include, but is not limited to, Zip® drives, flash memory cards, universal serial bus (USB) flash drives, secure digital (SD) cards, DVD disks, digital video tape, and the like. Computer-readable storage media 822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 818 may also include a computer-readable storage media reader 820 that can further be connected to computer-readable storage media 822. Reader 820 may receive and be configured to read data from a memory device such as a disk, a flash drive, etc.

In certain aspects, computer system 800 may support virtualization technologies, including but not limited to virtualization of processing and memory resources. For example, computer system 800 may provide support for executing one or more virtual machines. In certain aspects, computer system 800 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 800. Accordingly, multiple operating systems may potentially be run concurrently by computer system 800.

Communications subsystem 824 provides an interface to other computer systems and networks. Communications subsystem 824 serves as an interface for receiving data from and transmitting data to other systems from computer system 800. For example, communications subsystem 824 may enable computer system 800 to establish a communication channel to one or more client devices via the Internet for receiving and sending information from and to the client devices. For example, the communication subsystem may be used to transmit a response to a user regarding the inquiry for a Chabot.

Communication subsystem 824 may support both wired and/or wireless communication protocols. For example, in certain aspects, communications subsystem 824 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 824 can provide wired network connectivity (e.g., Ethernet) in addition to or instead of a wireless interface.

Communication subsystem 824 can receive and transmit data in various forms. For example, in some aspects, in addition to other forms, communications subsystem 824 may receive input communications in the form of structured and/or unstructured data feeds 826, event streams 828, event updates 830, and the like. For example, communications subsystem 824 may be configured to receive (or send) data feeds 826 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 824 may be configured to receive data in the form of continuous data streams, which may include event streams 828 of real-time events and/or event updates 830, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 824 may also be configured to communicate data from computer system 800 to other computer systems or networks. The data may be communicated in various different forms such as structured and/or unstructured data feeds 826, event streams 828, event updates 830, and the like to one or more databases that may be in communication with one or more streaming data source computers coupled to computer system 800.

Computer system 800 can be one of various types, including a handheld portable device (e.g., an iPhone® cellular phone, an iPad® computing tablet, a personal digital assistant (PDA)), a wearable device (e.g., a Google Glass® head mounted display), a personal computer, a workstation, a mainframe, a kiosk, a server rack, or any other data processing system. Due to the ever-changing nature of computers and networks, the description of computer system 800 depicted in FIG. 8 is intended only as a specific example. Many other configurations having more or fewer components than the system depicted in FIG. 8 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
receiving a request to generate synthetic data based on source data comprising a plurality of columns;
determining a set of columns of the source data that satisfy one or more correlation conditions and at least one other column of the source data that does not satisfy the one or more correlation conditions;
prompting a large language model to generate first synthetic data for at least the set of columns based at least in part on first source data values for the set of columns;
generating second synthetic data for the at least one other column based at least in part on a distribution of second source data values for the at least one other column;
merging the first synthetic data with the second synthetic data to generate a resulting synthetic set of data of the plurality of columns;
storing the resulting synthetic set of data in a repository of training data; and
using the training data to train a machine learning model.

2. The computer-implemented method of claim 1, wherein determining the set of columns of the source data that satisfy the one or more correlation conditions comprises determining a Pearson correlation for numeric columns and a similarity measure of vector embeddings for text columns.

3. The computer-implemented method of claim 1, further comprising causing display, on a user interface, of an option to remove a particular column from columns that would satisfy one or more correlation conditions, wherein the particular column, if removed, is not included in columns for which the large language model is prompted and is included in columns for which the second synthetic data is generated.

4. The computer-implemented method of claim 1, further comprising determining an upper limit and a lower limit of the second source data values, based at least in part on the distribution of second source data values for the at least one other column; wherein generating the second synthetic data comprises sampling from a range, defined by the upper limit and the lower limit of the second source data values.

5. The computer-implemented method of claim 1, wherein prompting the large language model to generate the first synthetic data comprises:
generating a plurality of prompts, each prompt comprising examples of a different subset of the first source data values for the set of columns, and
prompting the large language model with the plurality of prompts.

6. The computer-implemented method of claim 1, wherein prompting the large language model to generate the first synthetic data comprises:
generating a first prompt comprising a first set of examples of the first source data values for the set of columns, wherein the first prompt requests a first quantity of synthetic data items;
generating a second prompt comprising a second set of examples of the first source data values for the set of columns, wherein the second prompt requests a second quantity of synthetic data items that is different from the first quantity of synthetic data items; wherein the first set of examples is different from the second set of examples; and
prompting the large language model with the first prompt and the second prompt.

7. The computer-implemented method of claim 6, further comprising:
receiving a first set of the first quantity of synthetic data items from the large language model;
scoring a diversity of the first set of the first quantity of synthetic data items;
wherein the second quantity is selected based at least in part on the diversity of the first set of the first quantity of synthetic data items.

8. The computer-implemented method of claim 1, wherein the set of columns comprises a first column of a first dimension and a second column of a second dimension, wherein the request identifies the first column but does not identify the second column, wherein the method further comprises identifying the second column for inclusion in the source data based at least in part on a reference from the first dimension to a third column of the second dimension, and discovering the second column as a roll-up of the third column; wherein the first source data values include values from the second column and the third column, and wherein storing the resulting synthetic set of data in the repository of training data updates the first dimension membership of the third column on which the second column is determined; wherein first dimension membership of the second column is automatically determined as a roll-up value based at least in part on the first dimension membership of the third column.

9. The computer-implemented method of claim 1, wherein prompting the large language model to generate the first synthetic data comprises:
generating a prompt comprising:
an example range of existing values of a column of the set of columns, and
at least a subset of the first source data values of the set of columns, and prompting the large language model with the prompt.

10. The computer-implemented method of claim 1, wherein prompting the large language model to generate the first synthetic data comprises:
generating a prompt comprising:
a guideline indicating an aspect of a first column of the set of columns that depends on an aspect of a second column of the set of columns, and
at least a subset of the first source data values of the set of columns, and prompting the large language model with the prompt.

11. A computer-program product comprising one or more non-transitory machine-readable storage media, including stored instructions configured to cause a computing system to perform a set of actions including:
receiving a request to generate synthetic data based on source data comprising a plurality of columns;
determining a set of columns of the source data that satisfy one or more correlation conditions and at least one other column of the source data that does not satisfy the one or more correlation conditions;
prompting a large language model to generate first synthetic data for at least the set of columns based at least in part on first source data values for the set of columns;
generating second synthetic data for the at least one other column based at least in part on a distribution of second source data values for the at least one other column;
merging the first synthetic data with the second synthetic data to generate a resulting synthetic set of data of the plurality of columns;
storing the resulting synthetic set of data in a repository of training data; and
using the training data to train a machine learning model.

12. The computer-program product of claim 11, wherein the set of actions further includes:
causing display, on a user interface, of an option to remove a particular column from columns that would satisfy one or more correlation conditions, wherein the particular column, if removed, is not included in columns for which the large language model is prompted and is included in columns for which the second synthetic data is generated.

13. The computer-program product of claim 11, wherein prompting the large language model to generate the first synthetic data comprises:
generating a plurality of prompts, each prompt comprising examples of a different subset of the first source data values for the set of columns, and
prompting the large language model with the plurality of prompts.

14. The computer-program product of claim 11, wherein the set of columns comprises a first column of a first dimension and a second column of a second dimension, wherein the request identifies the first column but does not identify the second column, wherein the method further comprises identifying the second column for inclusion in the source data based at least in part on a reference from the first dimension to a third column of the second dimension, and discovering the second column as a roll-up of the third column; wherein the first source data values include values from the second column and the third column, and wherein storing the resulting synthetic set of data in the repository of training data updates the first dimension membership of the third column on which the second column is determined; wherein the second column first dimension membership of the second column is automatically determined as a roll-up value based at least in part on the first dimension membership of the third column.

15. The computer-program product of claim 11, wherein prompting the large language model to generate the first synthetic data comprises:
generating a prompt comprising:
a guideline indicating an aspect of a first column of the set of columns that depends on an aspect of a second column of the set of columns, and
at least a subset of the first source data values of the set of columns, and
prompting the large language model with the prompt.

16. A system comprising:
one or more processors;
one or more non-transitory computer-readable media storing instructions, which, when executed by the system, cause the system to perform a set of actions including:
receiving a request to generate synthetic data based on source data comprising a plurality of columns;
determining a set of columns of the source data that satisfy one or more correlation conditions and at least one other column of the source data that does not satisfy the one or more correlation conditions;
prompting a large language model to generate first synthetic data for at least the set of columns based at least in part on first source data values for the set of columns;
generating second synthetic data for the at least one other column based at least in part on a distribution of second source data values for the at least one other column;
merging the first synthetic data with the second synthetic data to generate a resulting synthetic set of data of the plurality of columns;
storing the resulting synthetic set of data in a repository of training data; and
using the training data to train a machine learning model.

17. The system of claim 16, wherein the set of actions further includes:
causing display, on a user interface, of an option to remove a particular column from columns that would satisfy one or more correlation conditions, wherein the particular column, if removed, is not included in columns for which the large language model is prompted and is included in columns for which the second synthetic data is generated.

18. The system of claim 16, wherein prompting the large language model to generate the first synthetic data comprises:
generating a plurality of prompts, each prompt comprising examples of a different subset of the first source data values for the set of columns, and
prompting the large language model with the plurality of prompts.

19. The system of claim 16, wherein the set of columns comprises a first column of a first dimension and a second column of a second dimension, wherein the request identifies the first column but does not identify the second column, wherein the method further comprises identifying the second column for inclusion in the source data based at least in part on a reference from the first dimension to a third column of the second dimension, and discovering the second column as a roll-up of the third column; wherein the first source data values include values from the second column and the third column, and wherein storing the resulting synthetic set of data in the repository of training data updates the first dimension membership of the third column on which the second column is determined; wherein the second column first dimension membership of the second column is automatically determined as a roll-up value based at least in part on the first dimension membership of the third column.

20. The system of claim 16, wherein prompting the large language model to generate the first synthetic data comprises:
generating a prompt comprising:
a guideline indicating an aspect of a first column of the set of columns that depends on an aspect of a second column of the set of columns, and
at least a subset of the first source data values of the set of columns, and
prompting the large language model with the prompt.
